(19) United States
(12) Patent Application Publication
(10) Pub. No.: US 2007/0157019 A1
(43) Pub. Date: Jul. 5, 2007

(54) Location-based network access

(75) Inventor: William York, Greenwood, IN (US)

Correspondence Address: SCHWABE, WILLIAMSON & WYATT, P.C., PACWEST CENTER, SUITE 1900, 1211 S.W. FIFTH AVE., PORTLAND, OR, 97204, US

(73) Assignee: Intel Corporation

(21) Appl. No.: 11/322,501

(22) Filed: Dec. 30, 2005

(51) Int. Cl. H04L 9/00

(52) U.S. Cl. 713/155

(57) ABSTRACT

A method, an article of manufacture, an apparatus, and a system for location-based network access are disclosed herein.

### TECHNICAL FIELD

Embodiments of the invention relate generally to the field of internetworking, specifically to methods and apparatuses associated with location-based network access.

### BACKGROUND

Network security has become a critical concern to many entities. From large corporations to single-office businesses, a common thread is a potential threat of unauthorized access to a network. These unauthorized users can access confidential and sensitive corporate information and may use such information to cause, among other things, great financial losses to the corporation. For example, a corporation storing information on some new and unpublicized intellectual property on its network could lose market leverage if an unauthorized user were to learn of the intellectual property and then publicly disseminate it. Importantly, the range of possibilities with regard to the type of damage that can be caused by such unauthorized access is wide-ranging.

Currently, an aspect of addressing the foregoing problem the requirement that authorized users log in to a network account on a network using a user identifier code and password. This process of verifying the user's identity may be called “authentication.” These network accounts generally are default enabled, meaning that the user can log in to the network account at anytime, from anyplace. In this mobile society, many users also have remote-access network accounts in addition to their on-premise network accounts. These remote-access network accounts generally are also default enabled even in a situation wherein the user has logged in to his on-premise network account.

Problems with the current method include the ability of an unauthorized user to access the authorized user's remote-access network account even if the authorized user is logged in to his on-premise network account and obviously would have no need to access his remote-access network account. Further, an unauthorized user can access an authorized user's on-premises network account simply by providing the authorized user's user identifier code and password, even if the authorized user is not on the premises.

### BRIEF DESCRIPTION OF THE DRAWINGS

Embodiments of the present invention will be readily understood by the following detailed description in conjunction with the accompanying drawings. Embodiments of the invention are illustrated by way of example and not by way of limitation in the figures of the accompanying drawings.

FIG. 1 illustrates a method for location-based network access incorporated with the teachings of the present invention, in accordance with various embodiments;

FIG. 2 illustrates a method for location-based network access incorporated with the teachings of the present invention, in accordance with various embodiments;

FIG. 3 illustrates an article of manufacture for location-based network access incorporated with the teachings of the present invention, in accordance with various embodiments;

FIG. 4 illustrates an apparatus for location-based network access incorporated with the teachings of the present invention, in accordance with various embodiments; and

FIG. 5 illustrates a system for location-based network access incorporated with the teachings of the present invention, in accordance with various embodiments.

### DETAILED DESCRIPTION

Illustrative embodiments of the present invention include but are not limited to methods for location-based network access, components contributing to the practice of these methods, in part or in whole, and systems endowed with such components.

In the following detailed description, reference is made to the accompanying drawings which form a part hereof and in which is shown by way of illustration embodiments in which the invention may be practiced. It is to be understood that other embodiments may be utilized and structural or logical changes may be made without departing from the scope of the present invention. Therefore, the following detailed description is not to be taken in a limiting sense, and the scope of embodiments in accordance with the present invention is defined by the appended claims and their equivalents.

Various operations may be described as multiple discrete operations in turn, in a manner that may be helpful in understanding embodiments of the present invention; however, the order of description should not be construed to imply that these operations are order dependent.

The description may use perspective-based descriptions such as up/down, back/front, and top/bottom. Such descriptions are merely used to facilitate the discussion and are not intended to restrict the application of embodiments of the present invention.

The description may use the phrases “in an embodiment,” or “in embodiments,” which may each refer to one or more of the same or different embodiments. Furthermore, the terms “comprising,” “including,” “having,” and the like, as used with respect to embodiments of the present invention, are synonymous.

The phrase “A/B” means “A or B”. The phrase “A and/or B” means “(A), (B), or (A and B)”. The phrase “at least one of A, B and C” means “(A), (B), (C), (A and B), (A and C), (B and C) or (A, B and C)”. The phrase “(A) B” means “(B) or (A B)”, that is, A is optional.

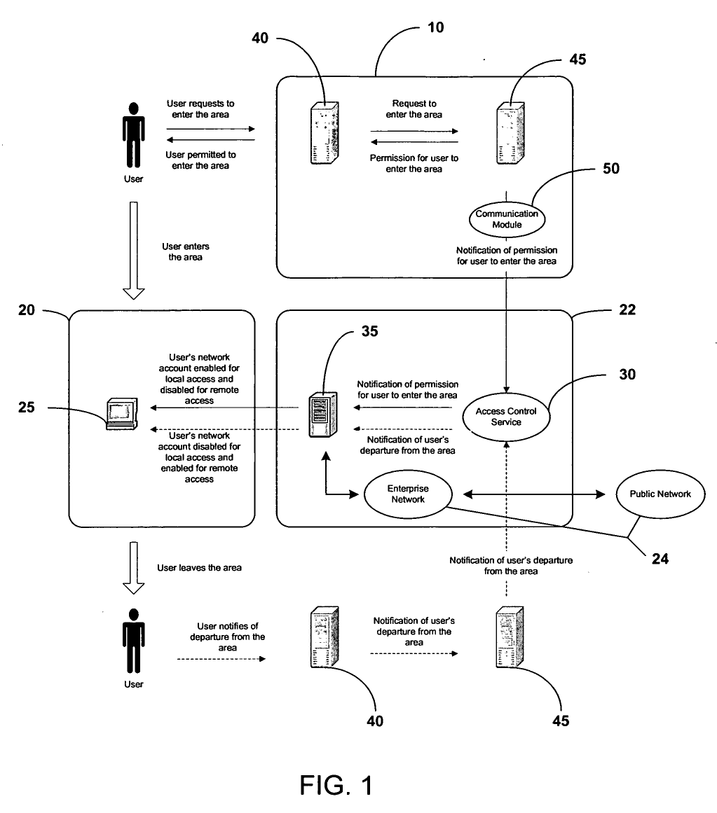

Referring now to FIG. 1, illustrated is an embodiment of methods for location-based network access in accordance with the present invention. As illustrated, in accordance with these embodiments, the method comprises receiving or retrieving a notification from a security system 10 of permission for a user to enter an area 20 and subsequently enabling the user to access a network 24 from a computing device 25 located in the area 20. In various ones of these embodiments, the user requests entry into an area 20 through a security system 10. In various ones of these embodiments, the security system 10 either permits or refuses entry of the user into the area 20 and the security system 10 in turn notifies or has available a notification of any permission. Further, in various ones of these embodiments, upon receiving or retrieving notification of the permission, an access control service 30 of an information technology infrastructure 22 may then enable the user's local-access network account.

In various embodiments in accordance with the present invention, a networking device 35 of the information technology infrastructure 22 is notified of the permission for a user to enter the area 20. In various ones of these embodiments, notification of such permission enables the user to access the network 24. In various ones of these embodiments, enabling the user to access the network may comprise activating a local-access network account for an access control service 30 controlling local access of the network 24, i.e., the user's local-access network account is active and can be accessed by the user. In various ones of these embodiments, the user may or may not be further required to provide a user identifier code and/or password. Alternatively, in various embodiments in accordance with this invention, enabling the user to access the network 24 may comprise enabling the user to gain access to the network by providing a valid password to a local-access network account of the user activated for an access control service 30 controlling local access of the network 24, i.e., until such activation, the network 24 is not accessible even though the user's account is activated and a valid password may be provided.

Still referring to FIG. 1, in various embodiments in accordance with this invention, the method may further comprise disabling the user from being able to remotely access the network 24. In various ones of these embodiments, disabling the user from being able to remotely access the network 24 may comprise deactivating a user's remote-access network account for an access control service 30 controlling remote access of the network 24, i.e., the user's remote-access network account is inactive and thus cannot be accessed by the user. Alternatively, in various ones of these embodiments, disabling the user from being able to remotely access the network 24 may comprise disabling the user from being able to remotely access the network 24 by providing a valid password to a remote-access network account of the user activated for an access control service 30 controlling remote access of the network, i.e., the user's remote-access network account is active but provision of a valid password nonetheless does not allow the user to log in.

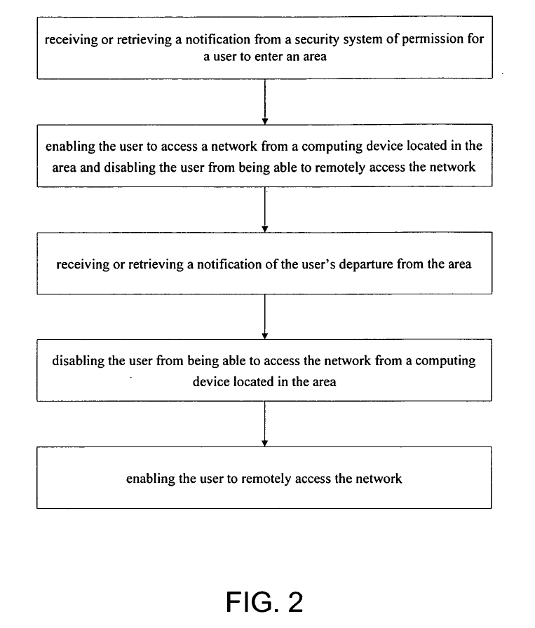

In various embodiments in accordance with this invention, the method may further comprise receiving or retrieving a notification of the user's departure from the area 20, disabling the user from being able to access the network 24 from a computing device 25 located in the area 20, and then enabling the user to remotely access the network 24 (see also FIG. 2). In various ones of these embodiments, disabling the user from being able to access the network from a computing device 25 located in the area 20 comprises deactivating the user's local-access network account, i.e., the user's local-access network account is inactive and thus cannot be accessed from any computing device 25 in the area 20. Alternatively, in various ones of these embodiments, disabling the user from being able to access the network may comprise disabling the user from accessing the network from a computing device 25 located in the area 20 even by providing a valid password, i.e., the user's local-access network account is active but even provision of a valid password does not enable the user to log in.

In various embodiments in accordance with this invention, the user departing from the area 20 enables the user to remotely access the network 24. Such remote access could be by dial-up or any similar type of means of accessing the network 24 from a location other than on the controlled premises, such as area 20. In various ones of these embodiments, enabling the user to remotely access the network may comprise activating the user's remote-access network account, i.e., the user's remote-access network account is active and can be accessed by the user, either by further requiring or not requiring the user to provide a user identifier code and/or password. Alternatively, in various embodiments, said enabling may comprise enabling the user to remotely access the network 24 by providing a valid password, i.e., the user's remote-access network account is activated as well as allowing provision of a valid password to gain access.

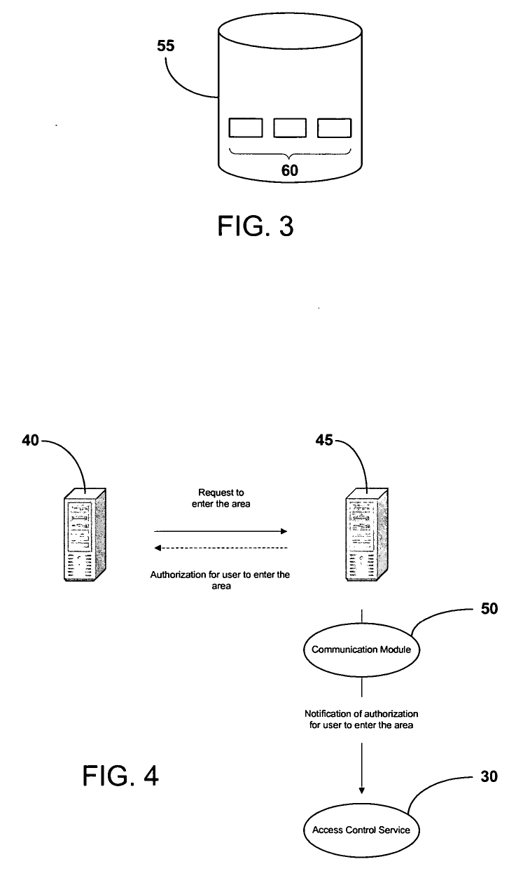

Turning now to FIG. 3, in various embodiments in accordance with the present invention, an article of manufacture for location-based network access comprises a storage medium 55 and a plurality of programming instructions 60 stored in the storage medium 55 adapted to program an apparatus to enable the apparatus receive or retrieve a notification from a security system of permission for a user to enter an area and subsequently enable the user to access a network from a computing device located in the area.

Regarding articles of manufacture in accordance with various embodiments, the programming instructions 60 may be further adapted to program the apparatus to enable the apparatus to (1) receive or retrieve a notification from a security system of permission for a user to enter an area, (2) enable the user to access a network from a computing device located in the area, (3) disable the user from being able to remotely access the network, (4) receive or retrieve a notification of the user's departure from the area, (5) disable the user from being able to access the network from a computing device located in the area, and then (6) enable the user to remotely access the network.

Turning now to FIG. 4 (or FIG. 1), in various embodiments in accordance with the present invention, an apparatus for location-based network access may comprise an input device 40 for receiving a user's request to enter an area; an authentication module 45 coupled to the input device 40, adapted to receive the entry request, authenticate the user, and if successful, permit the user to enter the area; and a communication module 50 coupled to the authentication module 45 and adapted to send a notification of the permission for an access control service 30 of an information technology infrastructure 22. In various ones of these embodiments, the user requests entry into an area by providing data and that data is received by an authentication module 45. In various ones of these embodiments, the authentication module 45 may then make a determination on the authenticity of the user based on the data (authentication) and permits the user to enter the area if the authentication module 45 makes a determination that the user is indeed authentic. Notification of such authentication is then sent to an access control service 30 by a communication module 50 coupled to the authentication device 45.

Regarding the communications module, in various ones of these embodiments, the communication module 50 may be variously adapted. For example, in various embodiments, the communication module 50 may be adapted to send the notification to the access control service 30. In yet another example, in various embodiments, the communication module 50 may be adapted to store a record of the permission for the user to enter an area in a storage location accessible by the access control service 30.

Regarding the input device 40, in various embodiments in accordance with the present invention, the input device 40 may be further adapted to capture a user's departure from the area and the communication module 50 may be further adapted to send a notification of the departure for the control access service.

In various embodiments in accordance with the present invention, the input device 40 may comprise a reader adapted to read a biometric of the user, an access instrument of the user, or a password or user identifier number of the user. For example, in various ones of these embodiments, the biometric of the user may comprise a fingerprint, an eye retina or iris pattern, a facial pattern, a handprint, a voice sound, or a written signature. This list of biometrics is not exhaustive as there are many unique human character traits that could be encompassed within the various embodiments of this invention.

Further, in various ones of these embodiments the access instrument of the user may comprise a radio frequency identification card (RFID), a magnetic stripe card, or an integrated circuit card. In can be envisioned by one skilled in the art that other access instruments could be used in accordance with various embodiments of this invention. For example, the access instrument is not meant to be limited to those in card form and could comprise those in any size, shape, and form.

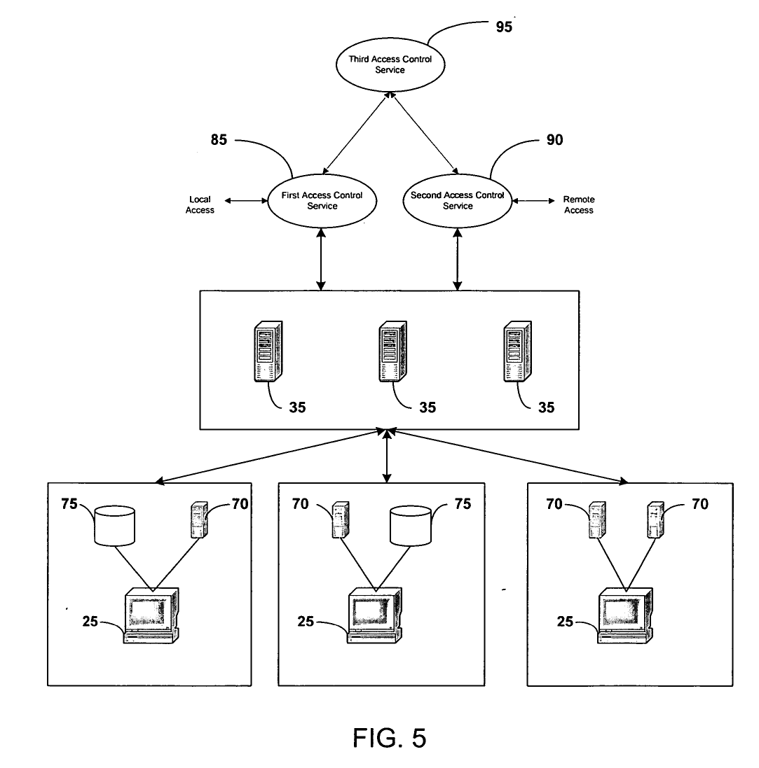

Turning now to FIG. 5, in various embodiments in accordance with the present invention, a system for location-based network access may comprise a plurality of computing and related peripheral devices 70 including one or more mass storage devices 75, a plurality of networking devices 35 coupled to the computing and associated peripheral devices 70, a first access control service 85, a second access control service 90, and a third access control service 95, coupled to each other as shown. In these embodiments, the first access control service 85 may be adapted to control local access to the plurality of computing and related peripheral devices 70, the second access control service 90 may be adapted to control remote access to the plurality of computing and related peripheral devices 70, and the third access control service 95 may be adapted to enable and disable the first 85 and second access control services 90 from enabling a user to locally and remotely access the computing and associated peripheral devices 70 respectively, based at least in part on entrance into and departure from an area.

In various embodiments of systems in accordance with the present invention, the aforementioned third access control service 95 may be variously adapted. For example, in various ones of these embodiments, the third access control service 95 may be adapted to enable the first access control service 85 to enable the user to have local access to the computing and peripheral devices 70 by activating a user's local-access network account for the first access control service 85. In these embodiments, the third access control service 95 may be further adapted to disable the first access control service 85 from being able to enable the user to have local access to the computing and peripheral devices 70 by deactivating the user's local-access network account for the first access control service 85. For example, in accordance with these various embodiments, an authenticated user entering an area may have his local-access network account activated for local use; however, the user's local-access network account may be deactivated for local use when the user leaves the area since the user no longer has a need for local access to his network account now that he has left the area. In various ones of these embodiments, activating the user's local-access network account for the first access control service 85 may mean that the user's account is active and thus can be accessed by the user. Regarding deactivating the user's local-access network account in these embodiments, deactivating the user network account may mean that the user's local-access network account is inactive from computing devices in the area and thus cannot be accessed in the area even by the user entering a valid user identifier code and/or password.

Further, in various embodiments, the third access control service 95 may be adapted to enable the second access control service 90 to enable the user to remotely access the computing and associated peripheral devices 70 by activating a user's remote-access network account for the second access control service 90, and further adapted to disable the second access control service 90 from being able to enable the user to remotely access the computing and associated peripheral devices 70 by deactivating the user's remote-access network account for the second access control services 90. For example, in accordance with these various embodiments, an authenticated user leaving an area may have his remote-access network account activated for remote use; however, the user's remote-access network account may be deactivated for remote use when the user re-enters the area since the user would no longer have a need for remote access to his network account since he is now within the area for local access to his network account.

Still further, in various embodiments, the third access control service 95 may be adapted to enable the first access control service 85 to enable the user to locally access the computing and associated peripheral device by enabling a user to gain local access by providing a password to a user's local-access network account activated for the first access control service 85, and disable the first access control service 85 from being able to enable the user to locally access the computing and associated peripheral devices 70 by disabling the user from being able to gain access to the computing and associated peripheral devices 70 by providing a password to the local-access network account of the user activated for the first access control service 85. For example, in accordance with these various embodiments, enabling the first access control service 85 to enable the user to locally access the network may comprise enabling the user to access the network from a computing device located in the area by providing a valid password, i.e., the user's local-access network account is active but the user may access it only by logging in. Similarly, in accordance with these embodiments, disabling the first access control service 85 from enabling the user to locally access the network from a computing device located in the area may comprise disabling the user to access his active local-access network account, i.e., the user's local-access network account is active but the user cannot access it even by providing a valid and correct user identifier code and/or password.

Still further, in various embodiments, the third access control service 95 may be adapted to enable the second access control services 90 to enable the user to remotely access the computing and associated peripheral devices 70 by enabling a user to gain remote access by providing a password to a user's remote-access network account activated for the second access control service 90, and disable the second access control service 90 from being able to enable the user to remotely access the computing and associated peripheral devices 70 by disabling the user from being able to gain access to the computing and associated peripheral devices 70 by providing a password to the remote-access network account of the user activated for the second access control services 90. For example, in accordance with these various embodiments, enabling the second access control service 90 to enable the user to remotely access the network may comprise enabling the user to access the network from a remote location by providing a valid password, i.e., the user's remote-access network account is active but the user may access it only by logging in. Similarly, in accordance with these embodiments, disabling the second access control service 90 from enabling the user to remotely access the network from a remote location may comprise disabling the user to access his active remote-access network account, i.e., the user's remote-access network account is active but the user cannot access it even by providing a valid and correct user identifier code and/or password.

In various embodiments, the first 85 and second 90 access control service may be one of the same access control service. In still other embodiments, the first 85, second 90, and third 95 control services may be different functions of the same access control service. In various embodiments, the local-access network account and the remote-access network account may be a remote and a local access privilege of a common network account.

Although certain embodiments have been illustrated and described herein for purposes of description of the preferred embodiment, it will be appreciated by those of ordinary skill in the art that a wide variety of alternate and/or equivalent embodiments or implementations calculated to achieve the same purposes may be substituted for the embodiments shown and described without departing from the scope of the present invention. Those with skill in the art will readily appreciate that embodiments in accordance with the present invention may be implemented in a very wide variety of ways. This application is intended to cover any adaptations or variations of the embodiments discussed herein. Therefore, it is manifestly intended that embodiments in accordance with the present invention be limited only by the claims and the equivalents thereof.

What is claimed is:

1. A method, comprising:
receiving or retrieving a notification from a security system of permission for a user to enter an area; and
enabling the user to access a network from a computing device located in the area.

2. The method of claim 1, wherein said enabling of the user to access the network comprises activating a user network account for an access control service controlling local access of the network.

3. The method of claim 1, wherein said enabling of the user to access the network comprises enabling the user to gain access to the network by providing a valid password to a network account of the user activated for an access control service controlling local access of the network.

4. The method of claim 1, further comprising disabling the user from being able to remotely access the network.

5. The method of claim 4, wherein the disabling of the user from being able to remotely access the network comprises deactivating a user network account for an access control service controlling remote access of the network.

6. The method of claim 4, wherein the disabling of the user from being able to remotely access the network comprises disabling the user from being able to remotely access a network by providing a valid password to a network account of the user activated for an access control service controlling remote access of the network.

7. The method of claim 1, further comprising:
receiving or retrieving a notification of the user's departure from the area;
disabling the user from being able to access the network from a computing device located in the area; and
enabling the user to remotely access the network.

8. The method of claim 7, wherein the disabling of the user from being able to access the network from a computing device located in the area comprises deactivating a user network account for an access control service controlling local access of the network.

9. The method of claim 7, wherein the disabling of the user from being able to access the network from a computing device located in the area comprises disabling the user from being able to access the network from a computing device located in the area by providing a password to a network account of the user activated for an access control service controlling local access of the network.

10. The method of claim 7, wherein the enabling of the user to remotely access the network comprises activating a user network account for an access control service controlling remote access of the network.

11. The method of claim 7, wherein the enabling of the user to remotely access the network comprises enabling a user to remotely gain access to a network by providing a valid password to a network account of the user activated for an access control service controlling remote access of the network.

12. An article of manufacture, comprising
a storage medium; and
a plurality of programming instructions stored in the storage medium adapted to program an apparatus to enable the apparatus to practice the method of claim 1.

13. The article of manufacture of claim 12 wherein the programming instructions are further adapted to program the apparatus to enable the apparatus to practice the method of claim 7.

14. An apparatus, comprising:
an input device to receive a request from a user to enter an area;
an authentication module coupled to the input device, and adapted to receive the request, and in response, authenticate the user, and if successful, permit the user to enter the area; and
a communication module coupled to the authentication module and adapted to send a notification of the permission for an access control service of an information technology infrastructure.

15. The apparatus of claim 14, wherein the communication module is adapted to send the notification to the access control service.

16. The apparatus of claim 14, wherein the communication module is adapted to store a record of the permission in a storage location accessible by the access control service.

17. The apparatus of claim 14, wherein the input device comprises a reader adapted to read a selected one of a biometric of the user, an access instrument of the user, and a password or user identifier number of the user.

18. The apparatus of claim 17, wherein the biometric comprises a selected one of a fingerprint, an eye retina pattern, an eye iris pattern, a facial pattern, a handprint, a voice sound, and a written signature.

19. The apparatus of claim 17, wherein the access instrument comprises a selected one of a radio frequency identification card, a magnetic stripe card, and an integrated circuit card.

20. The apparatus of claim 14, wherein the input device is further adapted to capture the user's departure from the area, and the communication module is further adapted to send a notification of the departure for the control access service.

21. A system comprising
a plurality of computing and associated peripheral devices including one or more mass storages;
a plurality of networking devices coupled to the computing and associated peripheral devices;
a first access control service adapted to control local access to the plurality of computing and related peripheral devices;
a second access control service adapted to control remote access to the plurality of computing and related peripheral devices; and
a third access control service adapted to enable and disable the first and second access control services from enabling a user to locally and remotely access the computing and associated peripheral devices respectively, based at least in part on entrance into and departure from an area.

22. The system of claim 21, wherein the third access control service is adapted to enable the first access control service to enable the user to locally access the computing and associated peripheral devices by activating a user network account for the first access control service, and to disable the first access control service from being able to enable the user to locally access the computing and associated peripheral devices by deactivating the user network account for the first access control service.

23. The system of claim 21, wherein the third access control service is adapted to enable the second access control service to enable the user to remotely access the computing and associated peripheral devices by activating a user network account for the second access control service, and to disable the second access control service from being able to enable the user to remotely access the computing and associated peripheral devices by deactivating the user network account for the second access control services.

24. The system of claim 21, wherein the third access control service is adapted to enable the first access control service to enable the user to locally access the computing and associated peripheral device by enabling a user to gain local access by providing a password to a user network account activated for the first access control service, and disable the first access control service from being able to enable the user to locally access the computing and associated peripheral devices by disabling the user from being able to gain access to the computing and associated peripheral devices by providing a password to the network account of the user activated for the first access control service.

25. The system of claim 21, wherein the third access control service is adapted to enable the second access control services to enable the user to remotely access the computing and associated peripheral devices by enabling a user to gain remote access by providing a password to a user network account activated for the second access control service, and disable the second access control service from being able to enable the user to remotely access the computing and associated peripheral devices by disabling the user from being able to gain access to the computing and associated peripheral devices by providing a password to the network account of the user activated for the second access control services.
